(19) United States
(12) Patent Application Publication
(10) Pub. No.: US 2007/0197235 A1
(43) Pub. Date: Aug. 23, 2007

(54) MULTIMEDIA BROADCAST MULTICAST SERVICE SESSION START METHOD AND SYSTEM THEREOF

(75) Inventor: Hai Zhang, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 11/548,813

(22) Filed: Oct. 12, 2006

Related U.S. Application Data
(63) Continuation of application No. PCT/CN05/00503, filed on Apr. 14, 2005.

(30) Foreign Application Priority Data
Apr. 14, 2004 (CN) 200410034467.4

(51) Int. Cl. H04Q 7/20

(52) U.S. Cl. 455/466

(57) ABSTRACT

The present invention discloses a Multimedia Broadcast/Multicast service (MBMS) session start method and a system thereof. The MBMS session start method includes the steps of: an MBMS Center (BM-SC) initiating a session start request message via a GGSN to an SGSN; receiving the MBMS session start request message, the SGSN sending the MBMS session start request message to an element of a Radio Access Network (RAN); receiving the MBMS session start request message, the element of the RAN checking whether to establish a bearer plane for the MBMS session, if establishing, activating an MBMS bearer context and the RAN establishing radio resources to the user equipment (UE). The element of the RAN may be a BSC/RNC. The method and the system thereof make it possible to optimize the system performance, reduce the resource waste of the radio network, and lower the complexity of the system processing.

### CROSS-REFERENCE TO RELATED APPLICATIONS

This application is a continuation of International Application No. PCT/CN2005/000503 filed Apr. 14, 2005. This application claims the benefit of Chinese Application No. 200410034467.4 filed on Apr. 14, 2004. The disclosures of the above applications are incorporated herein by reference.

### FIELD

The present disclosure relates to multimedia broadcast multicast services (MBMS) in a 3G mobile communication system, more particularly to an MBMS session start method and a system thereof.

### BACKGROUND

The statements in this section merely provide background information related to the present disclosure and may not constitute prior art.

With the development of the 3G mobile communication technology, services with a higher speed than those in the 2G mobile communication systems are provided, with more types, including such services as Videotel, image downloading, high-speed Internet browsing and etc, wherein, one service has the feature that the service content could be sent simultaneously to the users who subscribe to the service in the radio network, such as weather forecast, news short, sports game selection and etc. With the service feature of simultaneous transmission, the multicast/broadcast technology is introduced in the 3G mobile communication systems.

As shown in FIG. 1, which is a schematic diagram illustrating the working principle of MBMS, for an intermediate node, no matter how many downstream nodes, as 10, 101, or 102 shown in FIG. 1, are waiting to receive the data, the upstream node will send one set of data to the intermediate node; after receiving the data, the intermediate node will make data copies according to the number of downstream nodes waiting to receive the data, and distribute the data to the downstream nodes waiting to receive the data. In this way, one set of data will be transmitted in each branch of the MBMS data transmission tree and one set of resources for transmission is occupied, and it is the same for the data transmission from the root node to its downstream nodes. The difference between a multicast service and a broadcast service is that the service information is sent to the users who subscribe to the service in a multicast service instead of all the users in the radio network in a broadcast service. As the description shown above, the network resources could be saved remarkably by using MBMS to provide identical information simultaneously for a large number of users.

As shown in FIG. 2, which is a schematic diagram illustrating the radio network architecture for MBMS, in the prior art according to the 3^{rd} Generation Partnership Project (3GPP), the radio network architecture for MBMS services is that the Broadcast/Multicast Service Centre (BM-SC) 201 is connected to Gateway GPRS (General Packet Radio Service) Support Node (GGSN) 202 via the Gmb interface or Gi interface, wherein one BM-SC 201 may be connected to multiple GGSN 202; GGSN 202 is connected to Serving GPRS Support Node (SGSN) 203 via the Gn/Gp interface, wherein one GGSN 202 may be connected to multiple SGSN 203; SGSN 203 is connected to Universal Terrestrial Radio Access Network (UTRAN) 204 in the Universal Mobile Telecommunications System (UMTS) via the Iu interface and the UTRAN 204 is connected to the User Equipment (UE) 206 via the Uu interface; or SGSN 203 may be connected to GSM/EDGE Radio Access Network (GERAN) 205 in the Global System for Mobile communications (GSM) via the Iu/Gb interface and the GERAN 205 is connected to UE 207 via the Um interface.

An MBMS bearer context is used for storing the MBMS bearer capacity, which includes all the description information for defining an MBMS bearer and will be established on all the nodes bearing the MBMS data. As shown in Table 1, an MBMS bearer context includes IP multicast address, Access Point Name (APN), Temporary Mobile Group Identifier (TMGI), state, required MBMS bearer capacity, Quality of Service (QoS), MBMS service area, list of downstream node, the number of UEs and etc, wherein, the IP multicast address identifies the MBMS bearer described by the MBMS bearer context; the APN is the access point name defined for the IP multicast address; the TMGI is the temporary mobile group identifier assigned for the MBMS bearer; the state is the activity state of the MBMS bearer (‘static’ or ‘activated’) indicating whether to establish bearer plane resources for the MBMS data transmission; the required MBMS bearer capacity identifies the least bearer capacity for the UE; the QoS is the quality of service required by the MBMS bearer; the MBMS service area is the area to which the MBMS information will be sent; the list of downstream node includes the downstream nodes that have requested the MBMS bearer and to which the MBMS data should be sent; the number of UEs is the number of UEs which join the multicast service and are dominated by the node.

TABLE 1

| Parameter | Description | RAN | SGSN | GGSN | BM-SC |
|---|---|---|---|---|---|
| IP | Identifying the MBMS bearer | X | X | X | X |
| multicast | described by the MBMS bearer | | | | |
| address | context. | | | | |
| APN | Access point name defined for the | X | X | X | To be |
| | IP multicast address. | | | | studied |
| TMGI | Temporary mobile group identifier | X | X | X | X |
| | assigned for the MBMS bearer. | | | | |
| State | Activity state of the MBMS bearer | To be | X | X | X |
| | (‘static’ or ‘activated’) | studied | | | |
| Required | The least bearer capacity for the | | X | X | X |
| MBMS | UE | | | | |
| bearer | | | | | |
| capacity | | | | | |
| QoS | Quality of service required by the | X | X | X | X |
| | MBMS bearer. | | | | |
| MBMS | Area to which the MBMS | X | X | X | X |
| service | information will be sent. | | | | |
| area | | | | | |
| List of | List of the downstream nodes that | | X | X | X |
| downstream | have requested the MBMS bearer | | | | |
| node | and to which the MBMS data | | | | |
| | should be sent | | | | |
| Number | Number of the UEs which join the | To be | X | X | To be |
| of UEs | multicast service and are | studied | | | studied |
| | dominated by the node. | | | | |

According to the network architecture as shown in FIG. 2, the session start processes for a multicast service and a broadcast service of MBMS with the prior art are hereinafter described, respectively.

For an MBMS multicast service:

The users join the MBMS multicast service through an MBMS activation process, thus the network learns which users want to receive the information of a specific MBMS service.

Through an MBMS registration process, the network nodes can establish a distribution tree from BM-SC, via GGSN, SGSN, to Base Station Controller/Radio Network Controller (BSC/RNC), so as to allow the transmission for the attributes and data of an MBMS session. In the registration process, an MBMS bearer context can be established on the related nodes while no bearer plane is established.

As shown in FIG. 3, which is a schematic diagram illustrating the MBMS registration process with the cooperation of BSC/RNC and SGSN, when the BSC/RNC finds the UE dominated by itself is interested in the MBMS service but the BSC/RNC has not registered for the MBMS service, the registration process will be executed, including:

Step 301: the BSC/RNC sends an MBMS registration request message to its parent SGSN.

Step 302: upon receiving the registration request message from the BSC/RNC, the SGSN that has registered for the MBMS bearer service adds the BSC/RNC to the “list of downstream node” in the MBMS bearer context and returns an MBMS registration response message to the BSC/RNC.

The MBMS session start process will be initiated when the BM-SC is ready to transmit the data. The session start process activates all the bearer resources necessary to transmit the MBMS data in the network and notifies the interested UEs that the data transmission is to be started. By this process, the BM-SC provides the MBMS session attributes, such as QoS, MBMS service area, estimated session duration (if existing) for the related interested nodes. This process will also initiate other related processes executed by the BSC/RNC in the access network, such as sending a session notification, counting the cell users, choosing the radio bearer type, establishing radio and cabled bearer planes and etc.

FIG. 4 is a schematic diagram illustrating the session start process of an MBMS multicast service in the prior art. As shown in FIG. 4, the process includes:

Step 401: the BM-SC sends a session start request to the GGSN stored in the “list of downstream node” in the corresponding MBMS bearer context, indicating the data transmission is to be started, and sets the state attribute as “activated” in the MBMS bearer context. The session start request provides such session attributes as QoS, MBMS service area, the estimated session duration and etc.

Step 402: upon receiving the session start request message, the GGSN stores the session attributes obtained from the message in the MBMS bearer context, sets the state attribute of the MBMS bearer context as “activated”, and sends a session start response message to the BM-SC.

Step 403: the GGSN sends an MBMS session start request to the SGSN stored in the “list of downstream node” in the corresponding MBMS bearer context.

Step 404: upon receiving the MBMS session start request message, the SGSN stores the session attributes in the MBMS bearer context, sets the state attribute of the MBMS bearer context as “activated”, and sends an MBMS session start response message to the GGSN, wherein the response message provides the Tunnel Endpoint Identifier (TEID) for the bearer plane, and for the GGSN to transmit the MBMS data.

Step 405: the SGSN sends an MBMS session start request message containing the session attributes to each BSC/RNC connected to this SGSN.

Step 406: the BSC/RNC judges whether it is covered by the MBMS service area, if yes, the BSC/RNC stores the session attributes in the MBMS bearer context, sets the state attribute of the MBMS bearer context as “activated” and then executes step 407; otherwise, executes step 407 directly.

Step 407: the BSC/RNC sends an MBMS session start response message to the SGSN.

If the BSC/RNC is covered by the MBMS service area, the MBMS session start response message will include the TEID, by which the SGSN establishes the Iu bearer plane to transmit the MBMS data.

One BSC/RNC may receive multiple MBMS session start request messages carrying the parameter of the Iu bearer plane and return one MBMS session start response message to establish an Iu plane bearer to an SGSN.

If the BSC/RNC is not covered by the MBMS service area, the MBMS session start response message sent to the SGSN will include the information indicating that the BSC/RNC is not covered by the MBMS service area.

Then, the BSC/RNC will be able to establish in the MBMS service area the radio resources necessary to transmit the MBMS data to the interested UEs.

For an MBMS broadcast service:

As a broadcast service transmits the information to all the users in the radio network, it is not needed for the network nodes to execute the MBMS registration process.

FIG. 5 is a schematic diagram illustrating the session start process of an MBMS broadcast service in the prior art. As shown in FIG. 5, the process includes:

Step 501: the BM-SC sends a session start request message to the GGSN in the Public Land Mobile Network (PLMN), indicating the data transmission is to be started, and sets the state attribute of the MBMS bearer context as “activated”. The session start request provides such session attributes as QoS, MBMS service area, the estimated session duration and etc.

Step 502: upon receiving the session start request message, the GGSN establishes an MBMS bearer context and stores in the MBMS bearer context the session attributes obtained from the message, sets the state attribute of the MBMS bearer context as “activated”, and sends a session start response message to the BM-SC.

Step 503: the GGSN sends an MBMS session start request message to each SGSN.

Step 504: upon receiving the MBMS session start request message, the SGSN establishes an MBMS bearer context, stores the session attributes in the MBMS bearer context, sets the state attribute of the MBMS bearer context as “activated”, and sends an MBMS session start response message to the GGSN, wherein the response message provides the TEID for the bearer plane, for the GGSN to transmit the MBMS data.

Step 505: the SGSN sends an MBMS session start request message containing the session attributes to each BSC/RNC connected to the SGSN.

Step 506: the BSC/RNC judges whether it is covered by the MBMS service area, if yes, the BSC/RNC establishes an MBMS bearer context, stores the session attributes in the MBMS bearer context, sets the state attribute of the MBMS bearer context as “activated”, and then executes step 507; otherwise, executes step 507 directly.

Step 507: the BSC/RNC sends an MBMS session start response message to the SGSN.

If the BSC/RNC is covered by the MBMS service area, the MBMS session start response message will include the TEID, by which the SGSN establishes the Iu bearer plane to transmit the MBMS data.

One BSC/RNC may receive multiple MBMS session start request messages carrying the parameter of the Iu bearer plane and return one MBMS session start response message to establish an Iu plane bearer to an SGSN.

If the BSC/RNC is not covered by the MBMS service area, the MBMS session start response message sent to the SGSN will include the information indicating that the BSC/RNC is not covered by the MBMS service area.

Then, the BSC/RNC will be able to establish in the MBMS service area the radio resources necessary to transmit the MBMS data to the UEs.

In an MBMS session process, it is possible for some BSC/RNCs covered by the MBMS service area to be unable to establish associated MBMS session bearers when the BSC/RNC does not have sufficient radio resources or some errors occur, for example. In a session start process of MBMS multicast/broadcast services in the prior art, however, all the BSC/RNCs covered by the MBMS multicast service area will store the session attributes, set the session state to activate, and establish the associated bearers.

Therefore, the steps indicated in the above processes in the prior art lead to resource waste of the radio interface and make the system processing more complicated.

In the prior standards for a session start process of MBMS broadcast service, it is not required for the BM-SC to send down the parameter of estimated session duration. Therefore, the radio access network can not optimize the radio resource management for the MBMS broadcast service according to the session duration, thus decreasing the effectiveness of the radio interface.

In addition, in the session start process of MBMS multicast service, when the BSC/RNC is to establish an MBMS bearer, it may not have performed an MBMS registration process for the MBMS multicast service. In this case, the BSC/RNC that has not performed the MBMS registration process can not execute the session start process of an MBMS multicast service completely and thus can not implement the MBMS multicast service completely.

### SUMMARY

In view of the above, the present invention provides a session start method for MBMS and a system thereof, which could optimize system performance, reduce the resource waste of radio interface and lower the complexity of the system processing.

A Multimedia Broadcast/Multicast Service (MBMS) session start method is provided, which includes the steps of:

a Broadcast/Multicast Service Center (BM-SC) initiating a session start request message via a Gateway GPRS Support Node (GGSN) to a Serving GPRS Support Node (SGSN);

receiving the MBMS session start request message, the SGSN sending the MBMS session start request message to an element of a Radio Access Network (RAN); and

receiving the MBMS session start request message, the element of the RAN checking whether to establish a bearer plane for the MBMS session, if establishing, activating an MBMS bearer context and the element of the RAN establishing radio resources to the user equipment (UE).

A system for starting the session of MBMS Service is also provided, which includes: a BM-SC, a GGSN connected to the BM-SC, an SGSN connected to the GGSN, an element of a RAN connected to the SGSN, and a UE connected to the RAN. The BM-SC initiates a session start request message via the GGSN to the SGSN; the SGSN receives the MBMS session start request message and sends the MBMS session start request message to the element of the RAN; the element of RAN receives the MBMS session start request message, activates an MBMS bearer context and establishes radio resources to the UE if it is decided to establish a bearer plane for the MBMS session.

As shown in the above technical schemes, according to the session start method for MBMS of the present invention, after the BSC/RNC decides to establish an MBMS bearer will the BSC/RNC set the state of the bearer plane to activate and establish a bearer plane, thus optimizing the system performance, reducing the resource waste of the radio interface, and lowering the complexity of the system processing. In addition, in a session start process of an MBMS multicast service, it will be judged whether the BSC/RNC has performed an MBMS registration process, if not, a registration process will be executed before activating an MBMS bearer context. Therefore, an MBMS registration process is initiated when the registration has not been performed, thus ensures that the MBMS session start process could be implemented correctly and completely.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating the working principle of MBMS;

FIG. 2 is a schematic diagram illustrating the radio network architecture for MBMS;

FIG. 3 is a schematic diagram illustrating the MBMS registration process with the cooperation of BSC/RNC and SGSN;

FIG. 4 is a schematic diagram illustrating the session start process of an MBMS multicast service in the prior art;

FIG. 5 is a schematic diagram illustrating the session start process of an MBMS broadcast service in the prior art;

FIG. 6 is a schematic diagram illustrating the MBMS service area and the SGSN coverage;

FIG. 7 is a schematic diagram for the First Embodiment according to the present invention, illustrating the session start process of an MBMS multicast service;

FIG. 8 is a schematic diagram for the Second Embodiment according to the present invention, illustrating the session start process of an MBMS multicast service;

FIG. 9 is a schematic diagram for the Third Embodiment according to the present invention, illustrating the session start process of an MBMS broadcast service.

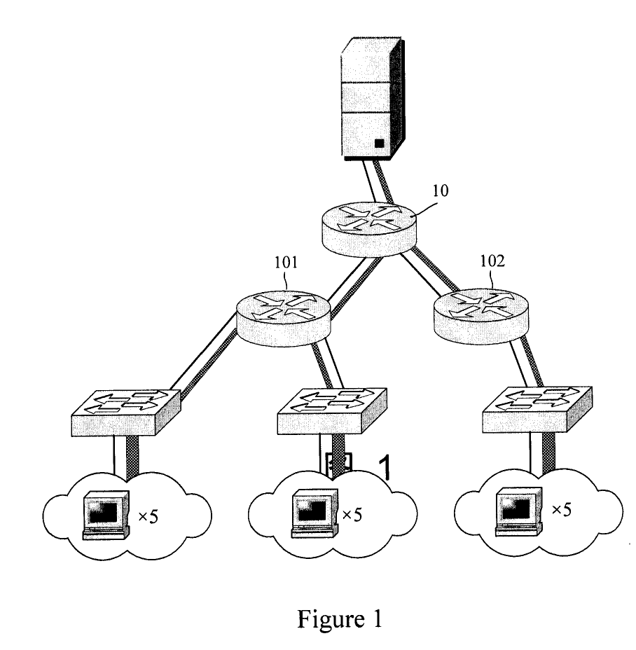

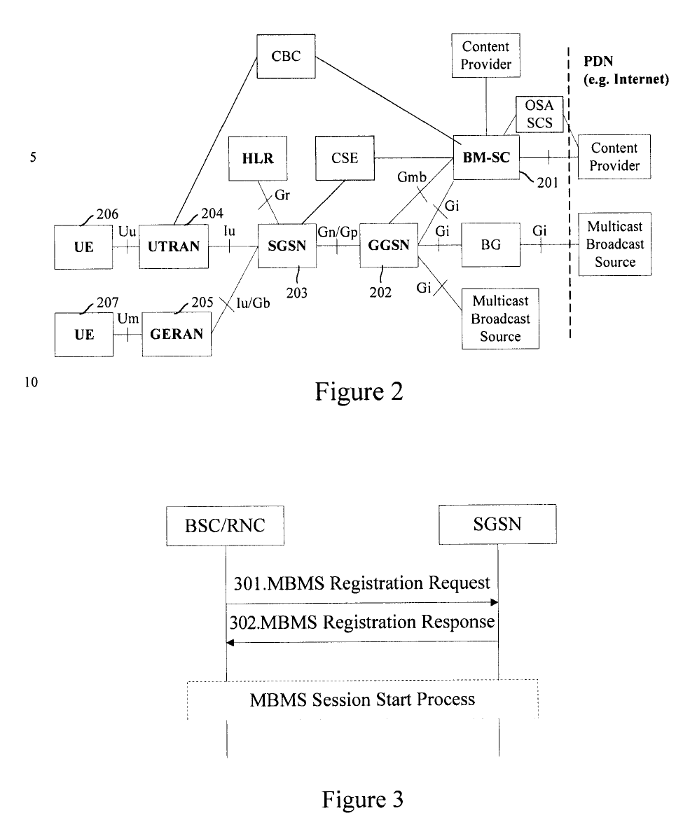

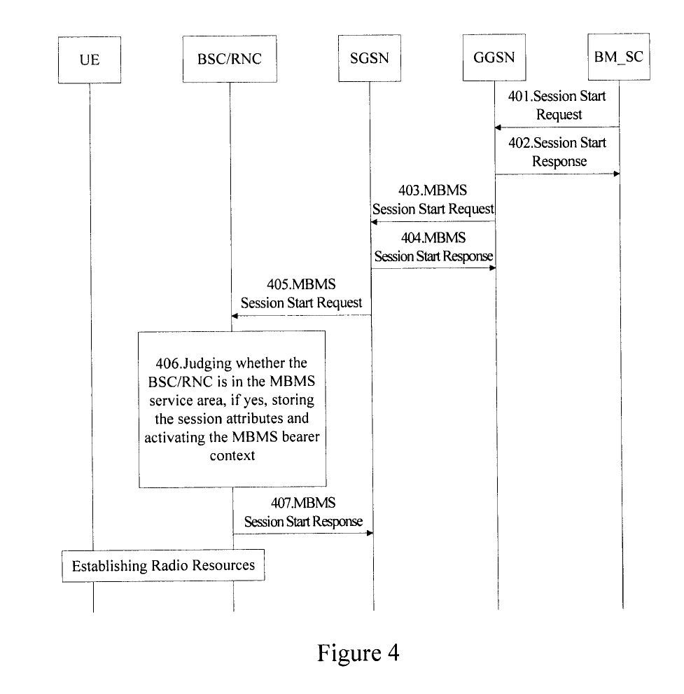

### DETAILED DESCRIPTION

The following description is merely exemplary in nature and is not intended to limit the present disclosure, application, or uses. It should be understood that throughout the drawings, corresponding reference numerals indicate like or corresponding parts and features.]

Four preferred embodiments according to the present invention are provided in detail.

FIG. 6 illustrates a schematic diagram illustrating the MBMS service area and the SGSN coverage of the present embodiment. The four preferred embodiments in the present invention are all implemented based on the condition shown in FIG. 6. A BM-SC is connected to a GGSN_X, the GGSN_X is connected to an SGSN_X. The SGSN_X dominates four elements of radio access network (RAN): BSC/RNC_A, BSC/RNC_B, BSC/RNC_C and BSC/RNC_D. In the present embodiment, the element of RAN is BSC in the 2G mobile communication network, and RNC in the 3G communication network. The MBMS service area covers part of BSC/RNC_A, part of BSC/RNC_B and part of BSC/RNC_C, respectively. The SGSN_X is in the list of downstream node for the GGSN_X, and the GGSN_X is in the list of downstream node for the BM-SC.

### First Embodiment

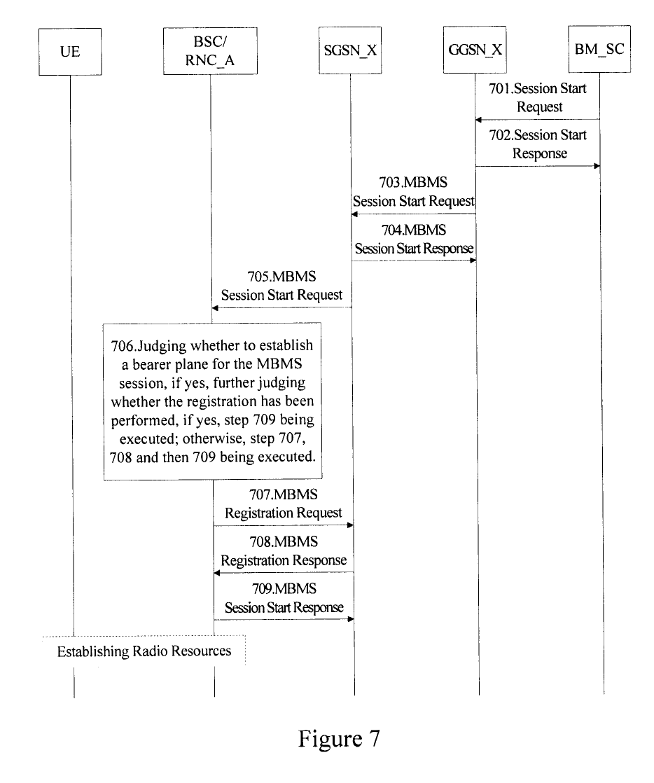

FIG. 7 illustrates a schematic diagram for the first Embodiment according to the present invention, illustrating the session start process of an MBMS multicast service, which includes the following steps:

Step 701: the BM-SC sends a session start request message to the GGSN stored in the “list of downstream node” in the corresponding MBMS bearer context, indicating the data transmission is to be started, and sets the state attribute of the MBMS bearer context as “activated”. The session start request message provides such session attributes as QoS, MBMS service area, estimated session duration and etc.

Step 702: upon receiving the session start request message, the GGSN_X stores the session attributes obtained from the request message in the MBMS bearer context, sets the state attribute of the MBMS bearer context as “activated”, and sends a session start response message to the BM-SC.

Step 703: the GGSN_X sends an MBMS session start request message to the SGSN_X stored in the “list of downstream node” in the corresponding MBMS bearer context.

Step 704: upon receiving the MBMS session start request message, the SGSN_X stores the session attributes in the MBMS bearer context, sets the state attribute of the MBMS bearer context as “activated”, and sends an MBMS session start response message to the GGSN_X, wherein the response message provides the TEID for the bearer plane, and for the GGSN to transmit the MBMS data.

Step 705: according to the MBMS service area information in the session attributes, the SGSN_X determines the cells overlapped by the MBMS service area and dominated by the BSC/RNCs connected to the SGSN_X, and then sends an MBMS session start request to each BSC/RNC corresponding to the determined cell. Specifically, the SGSN_X determines the cells covered at least partially by the MBMS service area among all the cells dominated by the BSC/RNCs connected to the SGSN_X, and sends an MBMS session start request message containing the session attributes to each BSC/RNC corresponding to the determined cell and serving the MBMS service area.

In this embodiment, among the cells dominated by the BSC/RNC_D, no cell is covered by the MBMS service area in this MBMS session, therefore, the SGSN_X sends the MBMS session start request messages to BSC/RNC_A, BSC/RNC_B and BSC/RNC_C, respectively.

Step 706: upon receiving the MBMS session start request message from the SGSN_X, the BSC/RNC_A, BSC/RNC_B or BSC/RNC_C determines whether to establish a bearer plane for the MBMS session, according to whether there is a user who needs to receive the MBMS session information and is located in one of the cells dominated by the corresponding BSC/RNC, and whether the corresponding BSC/RNC is capable of establishing the radio and cabled bearers for the MBMS session.

In practice, this step may be executed by the BSC in the Gb mode.

As for the BSC/RNC_A, if it decides to establish a bearer plane for the MBMS session, it will first examine whether it has performed an MBMS registration, i.e. examine whether there exists an MBMS bearer context for the MBMS service, if yes, it will store the session attributes in the MBMS bearer context, set the state attribute of the MBMS bearer context as “activated”, and then execute step 709; otherwise, it will store the session attributes in the MBMS bearer context, set the state attribute of the MBMS bearer context as “activated”, and then execute step 707, step 708 and then step 709. FIG. 7 shows the processing for BSC/RNC_A.

As for the BSC/RNC_B, if it decides to establish a bearer plane for the MBMS session and has performed the MBMS registration, it will store the session attributes in the MBMS bearer context, set the state attribute of the MBMS bearer context as “activated”, and then execute step 709 directly.

As for the BSC/RNC_C, it decides not to establish a bearer plane for the MBMS session due to such reasons as no user interested in the MBMS session, radio or cabled resource insufficiency of the BSC/RNC_C or occurrence of other errors in the cells dominated by the BSC/RNC_C. In this case, execute step 709 directly.

Steps 707-708: the BSC/RNC_A performs an MBMS registration process which is completely the same as that shown in FIG. 3, thus no further description is needed here.

Step 709: the BSC/RNC returns an MBMS session start response message to the SGSN_X.

As for the BSC/RNC_A or the BSC/RNC_B, the MBMS session start response message returned to the SGSN_X includes the TEID for the SGSN_X to establish the Iu bearer plane to transmit the MBMS data. Then, the BSC/RNC_A or the BSC/RNC_B will be able to establish in the MBMS service area the radio resources necessary to transmit the MBMS data to the interested UEs.

As for the BSC/RNC_C, the MBMS session start response message returned to the SGSN_X includes the information indicating the reason for not establishing the MBMS bearer plane.

### Second Embodiment:

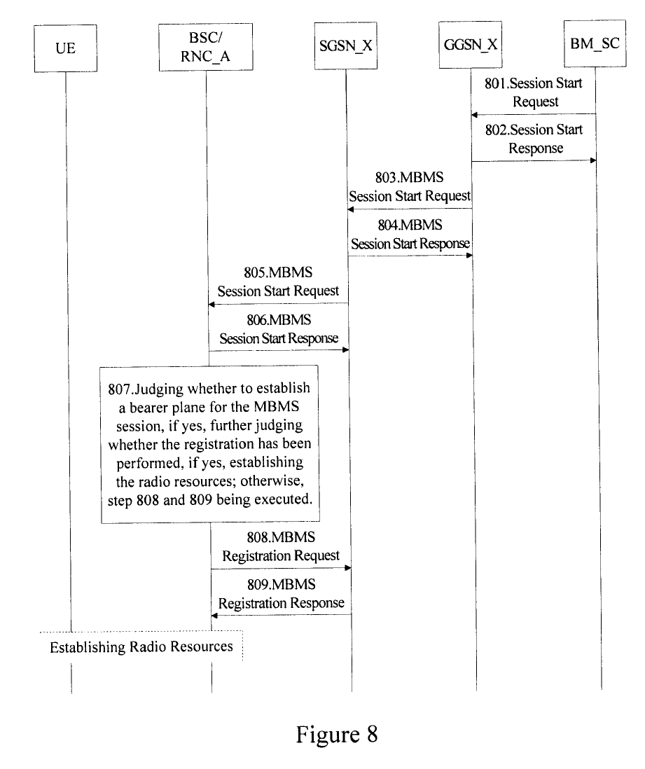

As shown in FIG. 8, which is a schematic diagram for the Second Embodiment according to the present invention, illustrating the session start process of an MBMS multicast service. The difference between the First embodiment and Second embodiment is that the BSC/RNC_A performs the MBMS registration process after sending the MBMS session start response message to the SGSN_X in the Second Embodiment as shown in FIG. 8 rather than before sending the MBMS session start response message to the SGSN_X in the First Embodiment as shown in FIG. 7.

### Third Embodiment

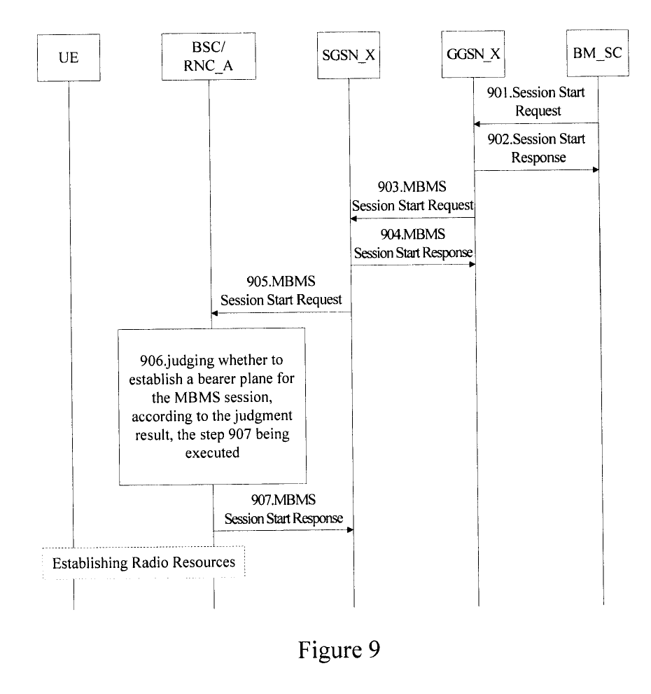

As shown in FIG. 9, which is a schematic diagram for the Third Embodiment according to the present invention, illustrating the session start process of an MBMS broadcast service, which includes the following steps:

Step 901: the BM-SC sends a session start request message to the GGSN in the PLMN, indicating the data transmission is to be started, and sets the state attribute of the MBMS bearer context as “activated”. The session start request message provides such session attributes as QoS, MBMS service area, estimated session duration and etc. If the BM-SC does not estimate the session duration, the session start request message will not provide the session attribute of the estimated session duration.

Step 902: upon receiving the session start request message, the GGSN_X establishes an MBMS bearer context, stores the session attributes obtained from the request message in the MBMS bearer context, sets the state attribute of the MBMS bearer context as “activated”, and sends a session start response message to the BM-SC.

Step 903: the GGSN_X sends an MBMS session start request message to the SGSN_X connected to the GGSN_X.

Step 904: upon receiving the MBMS session start request message, the SGSN_X establishes an MBMS bearer context, stores the session attributes in the MBMS bearer context, sets the state attribute of the MBMS bearer context as “activated”, and sends an MBMS session start response message to the GGSN_X, wherein the response message provides the TEID for the bearer plane, and for the GGSN to transmit the MBMS data.

Step 905: according to the MBMS service area information in the session attributes, the SGSN_X determines the cells overlapped by the MBMS service area and dominated by the BSC/RNCs connected to the SGSN_X, and then sends an MBMS session start request message containing the session attributes to each BSC/RNC corresponding to the determined cell.

In this embodiment, among the cells dominated by the BSC/RNC_D, no cell is covered by the MBMS service area in this MBMS session, therefore, the SGSN_X sends the MBMS session start request messages to BSC/RNC_A, BSC/RNC_B and BSC/RNC_C, respectively.

Step 906: upon receiving the MBMS session start request message from the SGSN_X, the BSC/RNC_A, BSC/RNC_B or BSC/RNC_C determines whether to establish a bearer plane for the MBMS session, according to whether there is a user who needs to receive the MBMS session information and is located in one of the cells dominated by the corresponding BSC/RNC, and whether the corresponding BSC/RNC is capable of establishing the radio and cabled bearers for the MBMS session.

As for the BSC/RNC_A or BSC/RNC_B, if it decides to establish a bearer plane for the MBMS session, it will store the session attributes in the MBMS bearer context, set the state attribute of the MBMS bearer context as “activated”, and then execute step 907.

As for the BSC/RNC_C, it decides not to establish a bearer plane for the MBMS session due to such reasons as no user interested in the MBMS session, radio or cabled resource insufficiency of the BSC/RNC_C or occurrence of other errors in the cells dominated by the BSC/RNC_C. In this case, execute step 907.

Step 907: the BSC/RNC returns an MBMS session start response message to the SGSN_X.

As for the BSC/RNC_A or the BSC/RNC_B, the MBMS session start response message returned to the SGSN_X includes the TEID for the SGSN_X to establish the Iu bearer plane to transmit the MBMS data. Then, the BSC/RNC_A or the BSC/RNC_B will be able to establish in the MBMS service area the radio resources necessary to transmit the MBMS data to the interested UEs. The BSC/RNC_A or the BSC/RNC_B will distribute the radio network resources according to the estimated session duration of the MBMS broadcast service in the session attributes together with the cooperation of the associated RRM arithmetic method.

As for the BSC/RNC_C, the MBMS session start response message returned to the SGSN_X includes the information indicating the reason for not establishing the MBMS bearer plane.

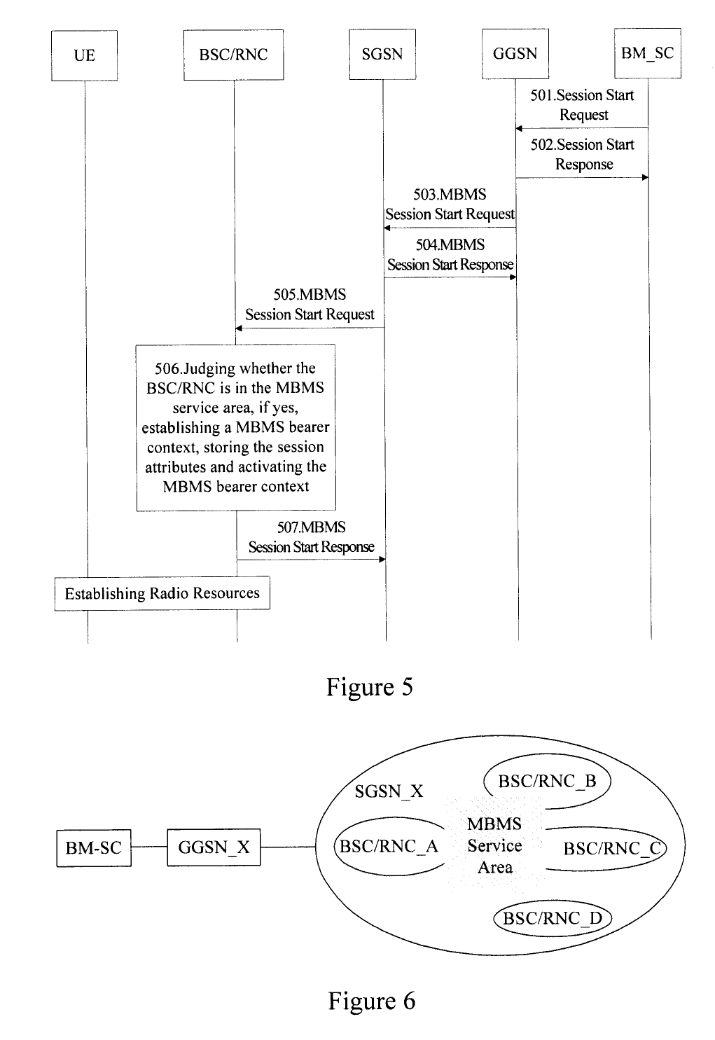

As a broadcast service will transmit information to all the users in the radio network, there is no MBMS registration process. Therefore, the main difference between the process in this embodiment and the process as shown in FIG. 7 or FIG. 8 is that there is no MBMS registration process for BSC/RNC_A. Meanwhile, compared with the process in the prior art as shown in FIG. 5, in the session start process in this embodiment, a parameter of estimated session duration is carried for the radio access network to distribute the radio network resources.

### Fourth Embodiment

In the process according to this embodiment, for either a multicast service or a broadcast service, the SGSN_X does not determine the BSC/RNCs connected to the SGSN_X and covered by the MBMS service area. Instead, the SGSN_X sends a session start request message to each BSC/RNC connected to the SGSN_X. After receiving the session start request message, the BSC/RNC_A, the BSC/RNC_B, the BSC/RNC_C or the BSC/RNC_D will first compare the cells dominated by the corresponding BSC/RNC with those in the MBMS service area according to the session start request message, and examine whether there is an overlap.

If there is, for a multicast service, execute step 706 and the following steps as shown in FIG. 7 or step 806 and the following steps as shown in FIG. 8, while for a broadcast service, execute step 906 and the following steps as shown in FIG. 9.

If there is not, no following steps will be executed. The BSC/RNC may further return an MBMS session response message to the SGSN to indicate the associated reason.

As shown in the above described embodiments, according to the session start method for MBMS in the present invention, the session start request messages are sent to the BSC/RNCs serving in the MBMS service area defined by this MBMS session, thus avoiding the unnecessary involvement of other unrelated BSC/RNCs. Furthermore, after the BSC/RNC decides to establish an MBMS bearer, will the BSC/RNC set the state of the bearer plane to activate and establish the bearer plane, thus optimizing the system performance, reducing the resource waste of the radio interface and lowering the complexity of the system processing. For an MBMS broadcast service, the parameter of estimated session duration is carried and used for the radio access network to distribute the radio network resources, while for an MBMS multicast service, the MBMS registration process will be initiated when the MBMS registration process is not performed, thus ensure a complete and correct implementation of the MBMS session start process.

The preferred embodiments of a system for starting the session of MBMS Service is also provided.

The system for starting the session of MBMS Service includes: a BM-SC, a GGSN connected to the BM-SC, an SGSN connected to the GGSN, an element of a RAN connected to the SGSN, and a UE connected to the RAN. The BM-SC initiates a session start request message via the GGSN to the SGSN; the SGSN receives the MBMS session start request message and sends the MBMS session start request message to the element of the RAN; the element of RAN receives the MBMS session start request message, activates an MBMS bearer context and establishes radio resources to the UE if it is decided to establish a bearer plane for the MBMS session.

In the system, the session start request message may be initiated for a multicast service, the GGSN may be the one stored in a list of downstream node in the corresponding MBMS bearer context. In this case, the BM-SC sends the session start request message to the GGSN and sets a state attribute of the MBMS bearer context to activate; the GGSN receives the session start request message, stores a session attribute obtained from the message into the MBMS bearer context, and sets the state attribute of the MBMS bearer context to activate, and sends a session start response message to the BM-SC; the GGSN sends the MBMS session start request message to the SGSN stored in the list of downstream node in the corresponding MBMS bearer context; the SGSN receives the MBMS session start request message, stores the session attribute into the MBMS bearer context, sets the state attribute of the MBMS bearer context to activate, and sends an MBMS session start response message to the GGSN, wherein the message provides a Tunnel End Identifier (TEID) for the bearer plane.

In the system, the session start request message may be initiated for a broadcast service, the GGSN is the one in the Public Land Mobile Network (PLMN). In this case, the BM-SC sends the session start request message to the GGSN and sets a state attribute of the MBMS bearer context to activate; the GGSN receives the session start request message, establishes an MBMS bearer context, stores a session attribute obtained from the message into the MBMS bearer context, sets the state attribute of the MBMS bearer context to activate, and sends a session start response message to the BM-SC; the GGSN sends the MBMS session start request message to the SGSN that is connected to the GGSN; the SGSN receives the session start request message, establishes an MBMS bearer context, stores the session attributes in the MBMS bearer context, sets the state attribute of the MBMS bearer context to activate, and sends a session start response message to the BM-SC, wherein the session start response message provides a TEID used for the bearer plane.

In the system, the session start request message may carry a session attribute of a parameter of estimated session duration.

In the system, the session start request message may carry session attributes of an MBMS service area and a parameter of estimated session duration; the element of the RAN is the one connected to the SGSN and dominates cells overlapped by the MBMS service area. In this case, the SGSN may determine the element of the RAN according to the MBMS service area and send the MBMS session start request message to each determined element of the RAN; the element of the RAN may establish the radio resources to the UE for transmitting the MBMS data according to the estimated session duration.

In the system, the element of the RAN may be a Base Station Controller (BSC)/Radio Network Controller (RNC).

In the system, in the case that the session start request message initiated by the BM-SC is for a multicast service, the element of the RAN may activate the MBMS bearer context after an registration process is performed successfully.

The above mentioned are preferred embodiments, but are not to confine the present invention. Those skilled in the art should understand that any modification or substitution can be easily made without departing from the scope of the present invention as defined by the appended claims.

What is claimed is:

1. A Multimedia Broadcast/Multicast Service (MBMS) session start method, comprising:
a Broadcast/Multicast Service Center (BM-SC) initiating a session start request message via a Gateway GPRS Support Node (GGSN) to a Serving GPRS Support Node (SGSN);
receiving the MBMS session start request message, the SGSN sending the MBMS session start request message to an element of a Radio Access Network (RAN); and
receiving the MBMS session start request message, the element of the RAN checking whether to establish a bearer plane for the MBMS session, if establishing, activating an MBMS bearer context and the element of the RAN establishing radio resources to the user equipment (UE).

2. The method according to claim 1, wherein the session start request message is initiated for a multicast service,
the BM-SC sending the session start request message to the GGSN stored in a list of downstream node in the corresponding MBMS bearer context, and setting a state attribute of the MBMS bearer context to activate;
receiving the session start request message, the GGSN storing a session attribute obtained from the message into the MBMS bearer context, setting the state attribute of the MBMS bearer context to activate, and sending a session start response message to the BM-SC;
the GGSN sending the MBMS session start request message to the SGSN stored in the list of downstream node in the corresponding MBMS bearer context; and
receiving the MBMS session start request message, the SGSN storing the session attribute into the MBMS bearer context, setting the state attribute of the MBMS bearer context to activate, and sending an MBMS session start response message to the GGSN, wherein the session start response message provides a Tunnel End Identifier (TEID) used for the bearer plane.

3. The method according to claim 1, wherein the session start request message is initiated for a broadcast service,
the BM-SC sending the session start request message to the GGSN in the Public Land Mobile Network (PLMN), and setting a state attribute of the MBMS bearer context to activate;
receiving the session start request message, the GGSN establishing the MBMS bearer context, storing a session attribute obtained from the message into the MBMS bearer context, setting the state attribute of the MBMS bearer context to activate, and sending a session start response message to the BM-SC; the GGSN sending the MBMS session start request message to the SGSN that is connected to the GGSN; and
receiving the session start request message, the SGSN establishing the MBMS bearer context, storing the session attribute into the MBMS bearer context, setting the state attribute of the MBMS bearer context to activate, and sending a session start response message to the BM-SC, wherein the session start response message provides a TEID used for the bearer plane.

4. The method according to claim 1, wherein the session start request message carries an MBMS service area;
the SGSN determining, according to the MBMS service area, the element of the RAN which is connected to the SGSN and dominate cells overlapped by the MBMS service area; and sending the MBMS session start request message to each determined element of the RAN.

5. The method according to claim 1, wherein the session start request message carries a session attribute of a parameter of estimated session duration.

6. The method according to claim 1, wherein the session start request message carries session attributes of an MBMS service area and a parameter of estimated session duration;
the SGSN determining, according to the MBMS service area, the element of the RAN which is connected to the SGSN and dominates cells overlapped by the MBMS service area; and sending the MBMS session start request message to each determined element of the RAN.
the element of the RAN establishing the radio resources to the UE for transmitting the MBMS data according to the estimated session duration.

7. The method according to claim 1, wherein the session start request message carries an MBMS service area;
the SGSN sending the MBMS session start request message to each element of the RAN that is connected with the SGSN; and
the element of the RAN checking whether the cells under its domination are overlapped with the MBMS service area, if overlapped, checking whether to establish a bearer plane for the MBMS session.

8. The method according to claim 1, wherein the element of the RAN is a Base Station Controller (BSC) in Gb mode.

9. The method according to claims 1, wherein checking whether to establish a bearer plane for the MBMS session according to whether a user in the cells dominated by the element of RAN needs to receive the MBMS session and whether the element of RAN is capable of establishing the bearer for the MBMS session.

10. The method according to claims 1, wherein the element of the RAN sending an MBMS session start response to the SGSN indicating the element of the RAN whether to establish the bearer plane for the MBMS session.

11. The method according to claims 1, wherein the session start request message initiated by the BM-SC is for a multicast service, the element of the RAN activating the MBMS bearer context after a registration process is performed successfully.

12. The method according to claim 11, wherein the registration process comprises:
the element of RAN sending an MBMS registration request message to the SGSN; and
receiving the MBMS registration request message, the SGSN adding the elements of RAN to a list of downstream node in the MBMS bearer context, and returning an MBMS registration response to the elements of RAN

13. The method according to claim 1, wherein the element of RAN is a Base Station Controller (BSC)/Radio Network Controller (RNC).

14. A system for starting the session of Broadcast/Multicast Service (MBMS) Service, comprising:
a Broadcast/Multicast Service Center (BM-SC);
a Gateway GPRS Support Node (GGSN) connected to the BM-SC;
a Serving GPRS Support Node (SGSN) connected to the GGSN;
an element of a Radio Access Network (RAN) connected to the SGSN; and
a User Equipment (UE) connected to the RAN;
wherein the BM-SC initiates a session start request message via the GGSN to the SGSN; the SGSN receives the MBMS session start request message and sends the MBMS session start request message to the element of the RAN; the element of RAN receives the MBMS session start request message, activates an MBMS bearer context and establishes radio resources to the UE if it is decided to establish a bearer plane for the MBMS session.

15. The system according to claim 14, wherein the session start request message is initiated for a multicast service, the GGSN is the one stored in a list of downstream node in the corresponding MBMS bearer context;
the BM-SC sends the session start request message to the GGSN and sets a state attribute of the MBMS bearer context to activate; the GGSN receives the session start request message, stores a session attribute obtained from the message into the MBMS bearer context, and sets the state attribute of the MBMS bearer context to activate, and sends a session start response message to the BM-SC; the GGSN sends the MBMS session start request message to the SGSN stored in the list of downstream node in the corresponding MBMS bearer context; the SGSN receives the MBMS session start request message, stores the session attribute into the MBMS bearer context, sets the state attribute of the MBMS bearer context to activate, and sends an MBMS session start response message to the GGSN, wherein the message provides a Tunnel End Identifier (TEID) for the bearer plane.

16. The system according to claim 14, wherein the session start request message is initiated for a broadcast service, the GGSN is the one in the Public Land Mobile Network (PLMN);
the BM-SC sends the session start request message to the GGSN and sets a state attribute of the MBMS bearer context to activate; the GGSN receives the session start request message, establishes an MBMS bearer context, stores a session attribute obtained from the message into the MBMS bearer context, sets the state attribute of the MBMS bearer context to activate, and sends a session start response message to the BM-SC; the GGSN sends the MBMS session start request message to the SGSN that is connected to the GGSN; the SGSN receives the session start request message, establishes an MBMS bearer context, stores the session attributes in the MBMS bearer context, sets the state attribute of the MBMS bearer context to activate, and sends a session start response message to the BM-SC, wherein the session start response message provides a TEID used for the bearer plane.

17. The system according to claim 14, wherein the session start request message carries a session attribute of a parameter of estimated session duration.

18. The system according to claim 14, wherein the session start request message carries session attributes of an MBMS service area and a parameter of estimated session duration; the element of the RAN is the one connected to the SGSN and dominates cells overlapped by the MBMS service area;
the SGSN determines the element of the RAN according to the MBMS service area and sends the MBMS session start request message to each determined element of the RAN.
the element of the RAN establishes the radio resources to the UE for transmitting the MBMS data according to the estimated session duration.

19. The system according to claim 14, wherein the element of the RAN is a BSC/RNC.

20. The system according to claim 14, wherein the session start request message initiated by the BM-SC is for a multicast service, the element of the RAN activates the MBMS bearer context after a registration process is performed successfully.
